(19) United States
(12) Patent Application Publication
(10) Pub. No.: US 2005/0081249 A1
(43) Pub. Date: Apr. 14, 2005

(54) Method for connecting a plurality of computer terminals to a broadband cable

(76) Inventors: Erik Richard Söderqvist, Tullinge (SE); Magnus Michael Sundberg, Sollentuna (SE)

Correspondence Address: CROWELL & MORING LLP;INTELLECTUAL PROPERTY GROUP, P.O. BOX 14300, WASHINGTON, DC, 20044-4300, US

(21) Appl. No.: 10/500,212

(22) PCT Filed: Dec. 18, 2002
(86) PCT No.: PCT/SE02/02367

(30) Foreign Application Priority Data
Dec. 27, 2001 (SE) 01 04420-5

(51) Int. Cl. H04L 12/28; H04N 7/173

(52) U.S. Cl. 725/118; 725/119

(57) ABSTRACT

A plurality of computer terminals (18), intended to be placed at different places within a restricted local area, are connected to an external broadband cable (19), intended for bidirectional transmission of data in the form of base band signals, by utilizing an existing local coaxial cable TV network (10) to which the computer terminals (18) and the broadband cable (19) are connected through the intermediary of modulator and demodulator means (22, 24) which are arranged to permit data to be transmitted on said network (10) in both directions between the computer terminals (18) and the broadband cable (19) in the form of modulated carrier signals having carrier frequencies lying outside the frequency bands utilized for the distribution of TV and/or radio signals on said network (10).

The present invention relates to a method for connecting a plurality of computer terminals, intended to be placed at different places within a restricted local area, to an external broadband cable, intended for bidirectional transmission of data in the form of base band signals.

In order to facilitate a transmission of data at a high speed between different computer users and a communication central, common to a large number of such users, it has become more and more frequent in recent years, from a communication central and to different local areas, to run broadband cables on which data can be transmitted in the form of optical or electric base band signals. However, in many cases, the connection of different computer users, residing within a certain local area, to the external broadband cable run to said area has been strongly delayed due to the fact that, hitherto, said connection has consistently been effected by running a separate connection line from said cable to each individual computer user, i.e. by a method that in practice implies a troublesome and time-consuming and hence costly installation.

The invention has for its purpose to provide an improved method of the kind initially specified which makes it possible to effect the desired connection between each separate computer terminal within the local area in question and the external broadband cable in a substantially simplified, more rapid and less costly manner.

The method according to the invention proposed for said purpose is primarily characterized by connecting the computer terminals to the broadband cable via an existing local coaxial cable network, serving to distribute TV and/or radio signals to different places within the local area in question, the computer terminals and the broadband cable being connected to said network through the intermediary of modulator and demodulator means which are arranged to permit data to be transmitted on said network in both directions between the computer terminals and the broadband cable in the form of modulated carrier signals having carrier frequencies within frequency bands lying outside the frequency bands used for the distribution of TV and/or radio signals.

The invention fully eliminates the previous need for installing special connection lines between the external broadband cable and the computer terminals.

In order to simplify the installation of the required supplementary equipment at each separate computer user location, the computer terminals may preferably be connected to the coaxial cable network via existing TV signal outlets of said network. This means that, if the coaxial cable network for instance is installed in an apartment block, the connection of the computer terminals to the coaxial cable network can be effected by the apartment owners themselves and thus, it is not required to engage an installer for said purpose.

The computer terminals may in this case suitably be connected to the existing TV signal outlets by means of respective connection units, each of which comprises means for separating TV signals transmitted on the network from data signals transmitted thereon and diverting the TV signals to a supplementary TV signal outlet and preferably also containing the modulator and demodulator means of the computer terminal in question.

In order to make a very broad carrier frequency band disposable for the data transmission between the broadband cable and the computer terminals, said cable and the computer terminals may be connected to the coaxial cable network through the intermediary of modulator and demodulator means which-are arranged to permit the data transmission on said network in both directions to be effected while utilizing carrier frequencies within frequency bands lying above the carrier frequency bands intended for the distribution of TV and/or radio signals. A suitable interval for the data transmission on the coaxial cable network is from about 900 MHz to about 2000 MHz.

In order to prevent unauthorized people from picking up the data signals transmitted to or from a certain computer terminal, the modulator and demodulator means used for connecting the broadband cable and the computer terminals to the coaxial cable network may, when so required, be arranged to permit the data transmission on said network to be effected while utilizing mutually different carrier frequencies for different computer terminals.

In order to facilitate a simultaneous data transmission to and from a computer terminal, i.e. full duplex, it is possible, for the connection of the broadband cable and the computer terminals to the coaxial cable network, to use modulator and demodulator means which are arranged to utilize mutually different carrier frequencies for the data transmission in mutually opposite directions on said network.

Below the invention is further described with reference to the accompanying drawings, in which

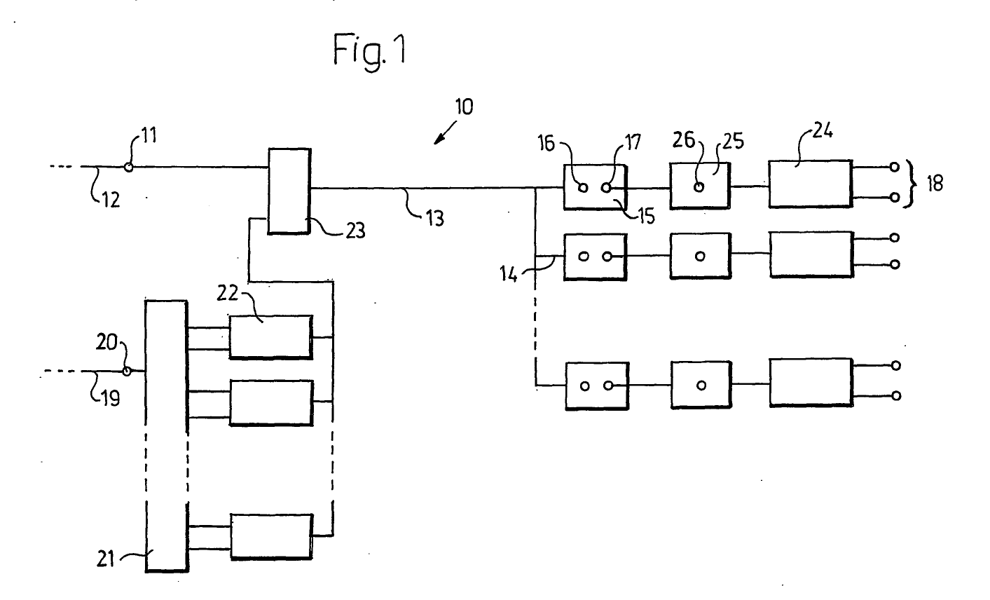

FIG. 1 shows a block diagram of a local installation, selected by way of example only, where the method according to the invention has been used for connecting a plurality of computer terminals to an external broadband cable,

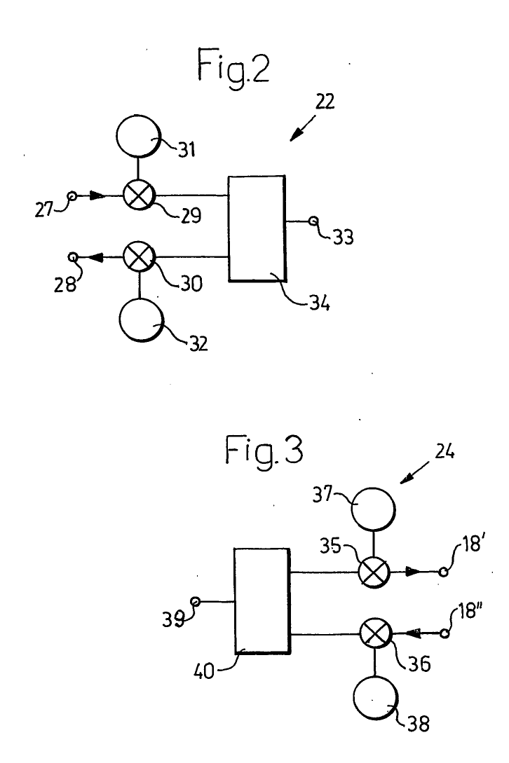

FIG. 2 shows a block diagram of a combined modulator and demodulator unit according to a first kind of such units contained in said installation, and

FIG. 3 shows a block diagram of a combined modulator and demodulator unit according to a second kind of such units contained in said installation.

In FIG. 1, reference numeral 10 generally designates a local coaxial cable TV network of tree and branch type comprising an input 11, intended to be connected to an external coaxial cable 12, on which, from an external source not shown, network 10 may be supplied with TV and radio signals consisting of modulated carrier signals having carrier frequencies lying within a predetermined frequency band, e.g. 47 to 860 MHz.

From input 11, said signals are distributed via a main line 13 of network 10 and a plurality of branch lines 14, connected to said main line, to a plurality of outlet boxes 15, connected each to one of said branch lines and provided at different subscribers and each of which comprises a radio signal outlet 16 and a TV signal outlet 17.

Apart from being used for the distribution of TV and radio signals, network 10 may also be used for bidirectional transmission of data in the form of modulated carrier signals between a plurality of computer terminals 18, provided at different subscribers, and an external broadband cable 19 on which said data can be transmitted in the form of base band signals to or from a communication central, not shown, which may be located at a large distance from the local area covered by network 10.

For this purpose, the installation comprises a coupling unit 21, connected to cable 19 via a combined input and output 20, and a plurality of combined modulator lator and demodulator units 22, connected to said coupling unit and forming a separate unit of said kind for each individual computer terminal 18. Units 22, the more detailed structure of which appears from FIG. 2, are all connected to network 10 via a diplex filter 23, connected in main line 13 and having for its purpose to prevent data signals transmitted on network 10 from being fed out on cable 12 and via said cable to other local networks and to prevent any disturbances appearing on cable 12 and having frequencies lying outside the frequency band utilized for the transmission of TV and radio signals from being transmitted to network 10.

Furthermore, the installation also comprises a corresponding plurality of combined modulator and demodulator units 24 which are connected each to the TV signal outlet 17 of one outlet box 15 via a connection unit 25 which is provided with a supplementary TV signal outlet 26 to which it is arranged to divert incoming TV signals. Unit 25, which in practice may be united with unit 24 and also computer terminal 18, may preferably comprise a diplex filter. The more detailed structure of units 24 appears from FIG. 3.

Units 22 have for their purpose to convert data, incoming in the form of base band signals from cable 19 via unit 21, to corresponding modulated carrier signals and to deliver the latter signals to line 13. In a corresponding manner, units 24 have for their purpose to convert data, incoming in the form of base band signals via computer terminals 18, to corresponding modulated carrier signals and to deliver the latter signals to network 10. Moreover, units 22 also serve to convert modulated carrier signals, transmitted to them from units 24 via network 10, to corresponding base band signals and to deliver the latter signals to unit 21 for subsequently outputting them on cable 19, while units 24 serve to convert modulated carrier signals, transmitted to them from units 22, to corresponding base band signals and to deliver the latter signals to the respective computer terminals 18.

As may be seen from FIG. 2, each unit 22 comprises an input 27, connected to unit 21 (FIG. 1), and an output 28, also connected to unit 21. Additionally, it also comprises two sine wave generators 31 and 32, connected each to one mixer 29 and 30, respectively, and a diplex filter 34, connected to a combined input and output 33 which in its turn is connected to diplex filter 23 (FIG. 1).

In a corresponding manner, each unit 24 comprises an output 18′ and an input 18″ which together form a computer terminal 18 (FIG. 1) to which a computer may be connected. Furthermore, each unit 24 also comprises two sine wave generators 37 and 38 which are connected each to one mixer 35 and 36, respectively, and a diplex filter 40, connected to a combined input and output 39 which in its turn is connected to connection unit 25 (FIG. 1).

In order to make sure that each separate unit 22 will cooperate in the above described manner only with the particular unit 24, intended to cooperate therewith, sine wave generators 31 and 37 of said two cooperating units are arranged to generate a sine wave having a predetermined unique frequency f′, while sine wave generators 32 and 38 of said two units are arranged to generate a sine wave having another predetermined unique frequency f″.

Hereby, mixer 29 will transform the data received via input 27 and consisting of base band signals to corresponding modulated carrier signals having the carrier frequency f′. When reaching mixer 35, the latter signals will then be demodulated by said mixer and become reconverted into base band signals that may be fed out via output 18′.

In corresponding manner, by means of mixer 36, base band signals incoming via input 18″ will be converted into corresponding modulated carrier signals having the carrier frequency f″ which then by means of mixer 30 are reconverted into base band signals that can be fed out via output 28.

For all pairs of cooperating units 22 and 24, said carrier frequencies may suitably be selected within a frequency band lying above the frequency bands utilized for the distribution of radio and TV signals. Thus, one may for instance use carrier frequencies within the interval from about 900 MHz to about 2000 MHz for the transmission of data.

The invention is not restricted to the embodiment above described and shown in the drawings. Instead, many other embodiments are feasible within the scope of the invention as defined in the following claims. By way of example, it could be mentioned that the invention may be applied also in connection with other types of local coaxial cable networks than tree and branch networks. For instance, the local network may consist of a star network. Finally, it should be mentioned that the expression “computer terminal” herein used is intended to include any kind of terminal or other connection means to which a computer may be directly or indirectly connected.

1-7. (canceled)

8. A method for connecting a plurality of computer terminals placed at different places within a restricted local area, to an external broadband cable for bidirectional transmission of data in the form of base band signals, said method comprising connecting the computer terminals to the broadband cable via an existing local coaxial cable network which forms a restricted local portion of a cable TV system and serves to distribute broadcast signals to different places within said area from an external broadcast signal source connected to said network by another external cable, wherein the computer terminals and the broadband cable are connected to said network through modulator and demodulator means which are arranged to permit data to be transmitted on said network in both directions between the computer terminals and the broadband cable in the form of modulated carrier signals having carrier frequencies within frequency bands lying above carrier frequency bands used for distributing the broadcast signals.

9. A method according to claim 8, wherein the computer terminals are connected to the local coaxial cable network via existing TV signal outlets of said network.

10. A method according to claim 9, wherein the computer terminals are connected to the existing TV signal outlets by respective connection units, each connection unit comprising means for separating TV signals transmitted on the local coaxial cable network from data signals transmitted on said network and diverting the TV signals to a supplementary TV signal outlet.

11. A method according to claim 10, wherein said connection units also contain the modulator and demodulator means for the respective computer terminals.

12. A method according to claim 1, wherein the modulator and demodulator means are arranged to permit the data transmission on the local coaxial cable network to be effected utilizing carrier frequencies in the range from about 900 MHz to about 2000 MHz.

13. A method according to claim 1, wherein the broadband cable and the computer terminals are connected to the local coaxial cable network through modulator and demodulator means arranged to permit the data transmission on said network to be effected utilizing mutually different carrier frequencies for different computer terminals.

14. A method according to claim 1, wherein the broadband cable and the computer terminals are connected to the local coaxial cable network through modulator and demodulator means arranged to permit mutually different carrier frequencies to be utilized for the data transmission in mutually opposite directions on said network.
